(19) United States
(12) Patent Application Publication
(10) Pub. No.: US 2025/0342177 A1
(43) Pub. Date: Nov. 6, 2025

(54) SYSTEM AND METHOD FOR CLASSIFICATION AND RECLASSIFICATION OF STRUCTURED AND UNSTRUCTURED DATA USING SIMILARITY-BASED SIGNATURES

(71) Applicant: Securiti, Inc., San Jose, CA (US)

(72) Inventors: Michael Busha, Menlo Park, CA (US); Michael Rinehart, Pleasanton, CA (US); Syed Muhammad Raza Abbas, Karachi (PK)

(21) Appl. No.: 19/196,767

(22) Filed: May 2, 2025

Related U.S. Application Data
(60) Provisional application No. 63/641,653, filed on May 2, 2024.

(51) Int. Cl. G06F 16/28; G06F 16/22

(52) U.S. Cl. CPC G06F 16/287; G06F 16/221

(57) ABSTRACT

Embodiments of the present disclosure relate to a system and method for classification and reclassification of structured and unstructured data using similarity-based signatures. Entities within a text document of structured and unstructured data are detected by a pre-trained artificial intelligence model. Multi-level embeddings are generated for each entity to capture contextual relationships, enabling calculation of similarity metrics and generation of similarity-based signatures. The entities are clustered based on the embeddings for purposes including visualization and batch classification. Clustering is performed in a first mode based on header information and data types, and in a second mode based on semantic meaning and format characteristics of column data. A user interface enables users to provide feedback on the clustering results, identifying cluster assignments as true positives or false positives. Based on the user feedback, the system reclassifies at least one entity, iteratively refining the AI model and enabling adaptive self-calibration for structured data management.

### EARLIEST PRIORITY DATE

This application claims priority from a Provisional patent application filed in the United States of America having Patent Application No. 63/641,653, filed on May 2, 2024, and titled “USING SIMILARITY-BASED SIGNATURES FOR EFFICIENT CLASSIFICATION AND MODIFICATION OF CLASSIFICATION FOR STRUCTURED DATA WITH OPTIONAL SELF-CALIBRATION”.

### FIELD OF INVENTION

Embodiments of the present disclosure relate to the field of data processing systems and more specifically to a system and method for the classification and reclassification of structured and unstructured data using similarity-based signatures. In particular, the invention pertains to techniques for efficiently classifying and modifying classifications of structured datasets using similarity metrics, with optional mechanisms for self-calibration or adaptive reclassification.

### BACKGROUND

Structured data classification plays a critical role in numerous applications ranging from enterprise data management and analytics to intelligent information retrieval and machine learning. Conventional classification systems, particularly those based on complex statistical or machine learning models, often operate as black boxes, obscuring the rationale behind individual classification outcomes. As structured datasets grow in dimensionality, the relationships between features become increasingly difficult to trace, and classification decisions become less transparent to end users. Typically, conventional methods for classifying structured data often encounter two significant challenges.

First, providing an interpretable representation of data assets remains a non-trivial problem. As datasets grow in size and complexity, classification models increasingly function as black boxes, making it difficult for users or domain experts to understand the rationale behind classification decisions. This lack of transparency reduces trust in the system and hinders meaningful collaboration between human users and automated tools.

Second, facilitating scalable and meaningful user feedback for classification systems is equally challenging. Existing methods frequently rely on manual labelling or rule-based updates that do not scale well with large or dynamic datasets. Further, scalability presents an additional set of concerns. Structured datasets frequently consist of millions of records and hundreds of features, often sourced from distributed or heterogeneous environments. Processing such data in real-time or near real-time places considerable demands on computation, memory, and throughput. Additionally, without a mechanism to incorporate user input in a principled and efficient way, the system cannot easily adapt to new requirements, errors, or evolving data patterns.

Furthermore, incorporating user feedback at scale poses a substantial challenge. Many existing systems lack the ability to integrate such feedback in a low-latency or incremental fashion, instead requiring full model retraining or manual rule updates.

In dynamic environments, structured data is also subject to schema evolution and data drift, where new fields may be introduced, or the statistical properties of the data may shift over time. Traditional classification systems are ill-equipped to accommodate such changes without significant reconfiguration.

Hence, there is a need for an improved system and method for which addresses the aforementioned issue(s).

### Objectives

The primary objective of the invention is to enable efficient, interpretable, and adaptable classification of structured data, while also incorporating user feedback in a scalable and semantically meaningful manner.

Another objective of the invention is to employ AI-based clustering which offers a nuanced view into data assets and allows user feedback to be directly applied to data clusters.

Yet another objective of the invention is to provide an additional layer of semantic similarity measurement which is cost-effective and productive.

Yet another objective of the invention is to provide an interactive interface for self-calibration by enabling users to dynamically adjust similarity thresholds based on column characteristics.

### BRIEF DESCRIPTION

In accordance with an embodiment of the present disclosure, a system for classification and reclassification of structured and unstructured data using similarity-based signatures. is provided. The system includes a processor and a machine-readable storage medium comprising instructions executable by the processor to detect, by a pre-trained intelligence model, a plurality of entities within a text document of structured data, generate, from each of the plurality of entities, multi-level embeddings configured to capture contextual relationships, wherein the embeddings enable calculation of similarity metrics and generation of similarity-based signatures, cluster the plurality of entities based on the embeddings for at least one of visualization and batch classification, wherein the clustering comprises a first mode configured to classify the plurality of entities based on header information and data types and a second mode configured to classify the plurality of entities based on semantic meaning and format characteristics of one or more column data, provide, by a user interface, an option for a user to submit feedback on the clustering results, wherein the feedback comprises identification of cluster assignments as one of a true positive and a false positive; and reclassify at least one of the plurality of entities based on user feedback wherein the reclassification iteratively refines the artificial intelligence model and facilitates adaptive self-calibration of structured data management.

In accordance with an embodiment of the present disclosure, a computer-implemented method implemented by a classification system is provided. The computer-implemented method includes detecting, by a pre-trained intelligence model, a plurality of entities within a text document of structured data, generating, from each of the plurality of entities, multi-level embeddings configured to capture contextual relationships, wherein the embeddings enable calculation of similarity metrics and generation of similarity-based signatures, clustering the plurality of entities based on the embeddings for at least one of visualization and batch classification wherein the clustering comprises a first mode configured to classify the plurality of entities based on header information and data types and a second mode configured to classify the plurality of entities based on semantic meaning and format characteristics of one or more column data, providing, by a user interface, an option for a user to submit feedback on the clustering results, wherein the feedback comprises identification of cluster assignments as one of a true positive and a false positive and reclassifying at least one of the plurality of entities based on user feedback wherein the reclassification iteratively refines the artificial intelligence model and facilitates adaptive self-calibration of structured data management.

In accordance with yet another embodiment of the present disclosure, a non-transitory computer-readable storage medium is provided. The non-transitory computer-readable storage medium includes instructions, the instructions being executable by a processing resource to cause detect, by a pre-trained intelligence model, a plurality of entities within a text document of structured data, generate, from each of the plurality of entities, multi-level embeddings configured to capture contextual relationships, wherein the embeddings enable calculation of similarity metrics and generation of similarity-based signatures, clustering the plurality of entities based on the embeddings for at least one of visualization and batch classification wherein the clustering comprises a first mode configured to classify the plurality of entities based on header information and data types and a second mode configured to classify the plurality of entities based on semantic meaning and format characteristics of one or more column data, provide, by a user interface, an option for a user to submit feedback on the clustering results, wherein the feedback comprises identification of cluster assignments as one of a true positive and a false positive and reclassifying at least one of the plurality of entities based on user feedback wherein the reclassification iteratively refines the artificial intelligence model and facilitates adaptive self-calibration of structured data management.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates a network environment for implementing example techniques for system for classification and reclassification of structured and unstructured data using similarity-based signatures in accordance with an embodiment of the present disclosure;

FIG. 2 illustrates a schematic diagram of a user device in accordance with an embodiment of the present disclosure;

FIG. 3 illustrates a schematic diagram of a system for classification and reclassification of structured and unstructured data using similarity-based signatures in accordance with an embodiment of the present disclosure;

FIG. 4 illustrates a method implemented by the classification system in accordance with an embodiment of the present disclosure; and

FIG. 5 illustrates a computing environment implementing a non-transitory computer-readable storage medium for classification and reclassification of structured and unstructured data using similarity-based signatures in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and a method for classification and reclassification of structured and unstructured data using similarity-based signatures. is provided. The system includes a processor and a machine-readable storage medium comprising instructions executable by the processor to detect, by a pre-trained intelligence model, a plurality of entities within a text document of structured and unstructured data, generate, from each of the plurality of entities, multi-level embeddings configured to capture contextual relationships, wherein the embeddings enable calculation of similarity metrics and generation of similarity-based signatures, cluster the plurality of entities based on the embeddings for at least one of visualization and batch classification, wherein the clustering comprises a first mode configured to classify the plurality of entities based on header information and data types and a second mode configured to classify the plurality of entities based on semantic meaning and format characteristics of one or more column data, provide, by a user interface, an option for a user to submit feedback on the clustering results, wherein the feedback comprises identification of cluster assignments as one of a true positive and a false positive; and reclassify at least one of the plurality of entities based on user feedback wherein the reclassification iteratively refines the artificial intelligence model and facilitates adaptive self-calibration of structured data management.

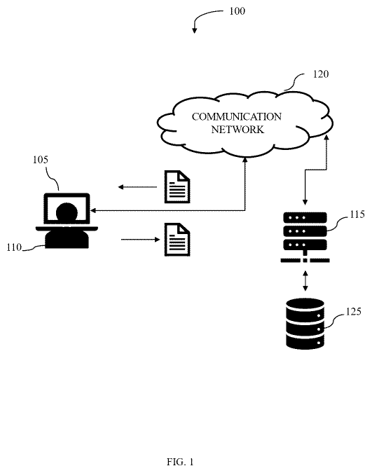

FIG. 1 illustrates a network environment for implementing example techniques for system for classification and reclassification of structured and unstructured data using similarity-based signatures in accordance with an embodiment of the present disclosure. Referring to FIG. 1, a user device 105 utilized by a user 110 may be communicatively coupled to a classification system 115 via a communication network 120. The communication network 120 may be a single communication network or a combination of multiple communication networks and may use a variety of different communication protocols. The communication network 120 may be a wireless network, a wired network, or a combination thereof. Examples of such individual communication networks include, but are not limited to, Global System for Mobile Communication (GSM) network, Universal Mobile Telecommunications System (UMTS) network, Personal Communications Service (PCS) network, Time Division Multiple Access TDMA) network, Code Division Multiple Access (CDMA) network, Next Generation Network (NON), Public Switched Telephone Network (PSTN). Depending on the technology, the communication network 120 may include various network entities, such as gateways and routers. However, such details have been omitted for the sake of brevity of the present description.

It may be noted that the foregoing system is an exemplary system and may be implemented as computer executable instructions in any computing or processing environment, including in digital electronic circuitry or in computer hardware, firmware, device driver, or software. As such, the system is not limited to any specific hardware or software configuration.

The classification system 115 may include one or more computing devices, such as one or more servers (for example, in a cloud deployment or in a data centre), one or more personal computers, and/or the like. The user device 105 may include a computing device, such as a desktop or laptop computer, a tablet, a mobile phone, etc. In an example, access to the classification system 115 may be provided as a web-link via a web browser on the user device 105 or a dedicated application installed on the user device 105. This application is not limited thereto.

The classification system 115 may be provided with a database 125. In an example implementation of the classification system 115 including one or more servers, the database 125 may a database local to the server or may be remote to the server. The database 125 may serve, amongst other things, as a repository for pre-storing multi-level embeddings from the plurality of entities and feedback from the user. It may be noted that the multi-level embeddings in the database 125 may be stored as a table or may be pre-stored as a mapping with the other. This application is not limited thereto.

Further, the classification system 115 may include a first processor(s) and a first memory(s). The first processor may fetch and execute the computer readable instructions stored in the first memory(s) to facilitate classification, amongst other functions. Similarly, the user device 105 may include a second processor(s) and a second memory(s). The second processor may fetch and execute the computer-readable instructions stored in the second memory(s) to facilitate classification, amongst other functions.

In operation, a Named Entity Recognition (NER) model is used to scan a text document and automatically detect entities. Entities are specific pieces of structured information like names, dates, organizations, addresses, or other data points. For each detected entity, the system generates embeddings. Embeddings are numerical representations that capture both the entity's local context (words or tokens nearby) and its larger context (paragraph, table, or document-wide features). This ensures that each entity's meaning is captured at multiple levels. Entities with similar embeddings (i.e., similar meanings or uses) are grouped into clusters. Clustering serves two purposes: to visualize groups of related entities for easier human inspection, and to facilitate batch classification, enabling faster processing of large datasets. Once clusters are created, a user or AI system reviews them. Each cluster can be marked as a true positive (correct detection) or a false positive (incorrect detection). Importantly, if a cluster is marked as a false positive, the system learns to automatically reject similar future detections without human intervention. The system applies the feedback not only to the current dataset but also propagates it forward to future data. This iterative refinement continuously improves detection accuracy and reduces false positive rates over time, creating a self-correcting, self-calibrating system.

In an embodiment, for processing unstructured data, the NER model is used to detect entities within the text document and embeddings are generated for each detected entity. In another embodiment, for processing structured or semi-structured data, embeddings are generated for entire columns based on the values and formats contained within the column, without requiring any prior entity detection step.

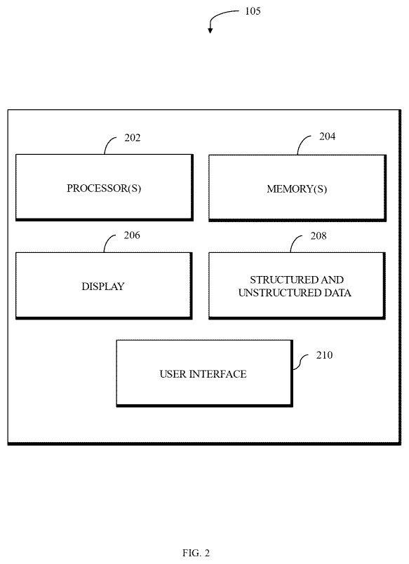

FIG. 2 illustrates a schematic diagram of a user device in accordance with an embodiment of the present disclosure. Referring to FIG. 2, the user device 105 may comprise a processor(s) 202, a memory(s) 204 coupled to and accessible by the processor(s) 202, and a user interface 210 coupled to the memory(s) 204. The user device 105 disclosed herein is the same as the user device 105 described in FIG. 1. The functions of various elements shown in the FIGS., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly comprise, without limitation, digital signal processor (DSP) hardware, network processor, application specific integrated circuit (ASIC), field programmable gate array (FPGA). Other hardware, standard and/or custom, may also be coupled to the processor(s) 202. The user device 105 may further include a display 206 in addition to other components such as, but not limited to, keyboard, sensors, logic circuits etc. Further, the user device 105 may include structured and unstructured data 208 which may include data that may be stored, utilized or generated during the operation of the user device 200.

The memory(s) 204 may be a computer-readable medium, examples of which comprise volatile memory (e.g., RAM), and/or non-volatile memory (e.g., Erasable Programmable read-only memory, i.e. EPROM, flash memory, etc.). The memory(s) 204 may be an external memory, or internal memory, such as a flash drive, a compact disk drive, an external hard disk drive, or the like. The user device 105 may further include an interface 210 that may allow the connection or coupling of the user device 105 with one or more other devices, through a wired (e.g., Local Area Network, i.e., LAN) connection or through a wireless connection (e.g., Bluetooth®, Wi-Fi), for example, for connecting to the classification system 115 shown in FIG. 1. The interface 210 may also enable intercommunication between different logical as well as hardware components of the user device 105.

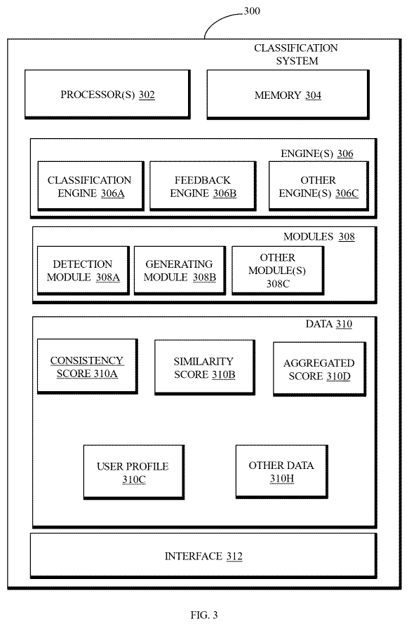

FIG. 3 illustrates a schematic diagram of a system for classification and reclassification of structured and unstructured data using similarity-based signatures in accordance with an embodiment of the present disclosure. Referring to FIG. 3, the classification system 300 include a processor(s) 302, a memory(s) 304 coupled to and accessible by the processor(s) 302, and an interface 312 coupled to the memory(s) 304. The system 300 disclosed herein may be same as the system 115 described in FIG. 1. The functions of various elements shown in the FIGS., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly comprise, without limitation, digital signal processor (DSP) hardware, network processor, application specific integrated circuit (ASIC), field programmable gate array (FPGA). Other hardware, standard and/or custom, may also be coupled to the processor(s) 302.

The memory(s) 304 may be a computer-readable medium, examples of which comprise volatile memory (e.g., RAM), and/or non-volatile memory (e.g., Erasable Programmable read-only memory, i.e. EPROM, flash memory, etc.). The memory(s) 304 may be an external memory, or internal memory, such as a flash drive, a compact disk drive, an external hard disk drive, or the like. The system 300 may further include an interface 312 that may allow the connection or coupling of the system 300 with one or more other devices, through a wired (e.g., Local Area Network, i.e., LAN) connection or through a wireless connection (e.g., Bluetooth®, Wi-Fi), for example, for connecting to the user device 105 shown in FIG. 1. The interface 312 may also enable intercommunication between different logical as well as hardware components of the system 300.

The system 300 may further include engine(s) 306. The engine(s) 306 may be implemented as a combination of hardware and programming, for example, programmable instructions to implement a variety of functionalities of the engine(s) 306. In examples described herein, such combinations of hardware and programming may be implemented in several different ways. For example, the programming for the engine(s) 306 may be executable instructions. Such instructions may be stored on a non-transitory machine-readable storage medium which may be coupled either directly with the system 300 or indirectly (for example, through networked means). In an example, the engine(s) 306 may include a processing resource, for example, either a single processor or a combination of multiple processors, to execute such instructions. In the present examples, the non-transitory machine-readable storage medium may store instructions that, when executed by the processing resource, implement engine(s) 306. In other examples, the engine(s) 306 may be implemented as electronic circuitry.

The engine(s) 306 includes a classification engine 306A, a feedback engine 306B and other engine(s) 306C. The other engine(s) 306C may further implement functionalities that supplement functions performed by the system 300 or any of the engine(s) 306. Further, the system 300 includes data 310. The data 310 may include data that is either stored or generated as a result of functions implemented by any of the engine(s) 306 or the system 300. It may be further noted that information stored and available in data 310 may be utilized by the engine(s) 306 for performing various functions by the system 300. In an example, data 310H includes a text document of structured and unstructured data. It may be noted that such examples of the various functions are only indicative. The present approaches may be applicable to other examples without deviating from the scope of the present subject matter.

Further, the system 300 may include module(s) 308. The module(s) 308 may include detection module 308A, a generating module 308B and other modules(s) 308C. In one example, the module(s) 308 may be implemented as a combination of hardware and firmware. In an example described herein, such combinations of hardware and firmware may be implemented in several different ways. For example, the firmware for module(s) 308 may be processor 302 executable instructions stored on a non-transitory machine-readable storage medium and the hardware for the module(s) 308 may include a processing resource (for example, implemented as either single processor or combination of multiple processors), to execute such instructions.

In the present examples, the non-transitory machine-readable storage medium may store instructions that, when executed by the processing resource, implement the functionalities of modules(s) 308. In such examples, the classification system 115 may include the machine-readable storage medium storing the instructions and the processing resource to execute the instructions. In other examples of the present subject matter, the machine-readable storage medium may be located at a different location but accessible to the system 300 and the processor(s) 302.

In operation, in order to access the system 300, the user may have to register with the system 300. A registration module (not shown in FIG. 3) may be configured to facilitate registration of the user via the user device. In an example, the registration as provided herein may include creation of user account with the system 300 by providing details such as, but not limited to, username, phone number, address, email, password, and other details. Upon registration, a user profile 310C or account corresponding to the user 110 is created with some of the details provided by the user 110 determined as credentials. Further, a login module (not shown in FIG. 3) may be configured to facilitate the user 110 to utilize the credentials to gain access to the system 300. In an example, the credentials may include user 110 providing username and password for logging into the system 300.

Upon successful login of the user into the system via the user device, the classification system may cause to detect, by a pre-trained intelligence model, a plurality of entities within a text document of structured and unstructured data. The pre-trained artificial intelligence model, such as a named entity recognition (NER) model or equivalent structured data analysis model, is utilized to automatically detect a plurality of entities within a text document comprising structured and unstructured data. The detection step includes parsing the text document to identify and extract discrete information units, wherein each information unit corresponds to a semantic or structural element of interest, such as a field, record, attribute, or named entity. The pre-trained model is configured to recognize patterns, contextual cues, and data relationships within the document, enabling accurate extraction of relevant entities without requiring manual intervention or schema-specific customization.

In one embodiment, the system is configured to assign a consistency score 310A to each column or entity detected in the structured and unstructured data. The consistency score 310A measures the internal coherence, stability, or uniformity of the data within a specific column. For example, if all the values in a column are similarly formatted (e.g., all are two-digit numbers, or all follow the same text pattern), the column would receive a high consistency score 310A. If the values in a column are mixed, irregular, or vary widely in format or meaning, it would receive a lower consistency score 310A.

Further, the consistency score 310A can then be used to perform two types of actions namely, directing the user for review or automatically updating the column. The system can prioritize and highlight columns with low consistency scores or suspicious patterns, drawing the user's attention to columns that may require manual review. For example, a user might be shown a list of columns ranked by consistency, where the lowest-ranked ones are recommended for closer inspection, correction, or validation. Alternatively, based on the consistency score 310A, the system can automatically perform updates or corrections on certain columns without needing user intervention. For instance, if a column has a very high consistency score and matches known patterns, the system might automatically classify, tag, or group it with minimal risk of error.

For each of the plurality of detected entities, multi-level embeddings are generated, wherein the embeddings are numerical representations configured to capture both local and broader contextual relationships associated with each entity. The multi-level embeddings may include, but are not limited to, representations derived from immediate textual context, structural features, semantic meaning, and global document positioning. The generated embeddings enable the calculation of similarity metrics between entities by encoding contextual similarities and dissimilarities in a machine-computable format. Based on the embeddings, similarity-based signatures are constructed for each entity, wherein the signatures uniquely characterize entities with respect to their contextual and semantic attributes, thereby facilitating downstream tasks such as clustering, classification, and reclassification.

In one embodiment, the embeddings are All-MiniLM-L6-v2 to distinguish between the plurality of columns.

In another embodiment, each column of the plurality of entities is embedded as a high-dimensional vector.

In yet another embodiment, the embeddings are stored in a database to enable further clustering as required. In such an embodiment, stored embeddings are used to perform clustering.

The plurality of entities are clustered based on the generated multi-level embeddings, wherein the clustering facilitates at least one of visualization, batch classification, schema inference, or data organization. The clustering operation is configured to selectively operate in multiple modes, including: (i) a first mode, wherein classification of entities is performed based on syntactic features such as header information and associated data types, and (ii) a second mode, wherein classification is performed based on semantic meaning and format characteristics derived from the underlying content of one or more columns of structured and unstructured data. The first mode signifies a table schema clustering, and the second mode signifies a column content clustering. In certain embodiments, a hybrid clustering mode is further provided, wherein the first mode and second mode are applied individually, sequentially, or in combination, thereby allowing the system to adaptively refine clustering strategies based on the quality, consistency, or semantic richness of the data. The clustering process enables improved interpretability, management efficiency, and scalability for downstream classification and reclassification operations.

In one embodiment, the semantic similarity between columns of structured and unstructured data is computed using modern, pre-trained sentence embedding models. These models are designed to transform text inputs into high-dimensional vector representations that capture the semantic meaning of the input in a machine-readable form. In particular, models such as All-MiniLM-L6-v2 are utilized, which have demonstrated remarkable effectiveness in distinguishing between unrelated data classes with minimal computational resources.

The process begins by embedding each column of structured and unstructured data individually. The embedding operation involves passing the column's data-such as concatenated values, sampled entries, or header information-through the pre-trained model to produce a corresponding high-dimensional vector. These vectors are designed to capture both the syntactic structure and the underlying semantic content of the columns.

In one embodiment, display one or more similarities between the plurality of columns using a distance metric via the user interface. After the embeddings are generated and the similarity computations are performed (such as through semantic, distributional, or morphological signals), the system computes a similarity or distance score between the columns. A distance metric is used to quantify how similar or different the columns are. The distance metric can be, for example, cosine similarity, Euclidean distance, Manhattan distance, or any other mathematical function that measures closeness between two high-dimensional vectors (representing columns). Once the similarity or distance scores are calculated, the system instructs the user interface (UI) to display these scores. The display could be in the form of tables, matrices, graphs, clustering trees (dendrograms), heatmaps, or any visualization method that shows how similar or dissimilar the columns are to each other. This enables the user to visually analyse which columns are closely related (high similarity/low distance) and which are distinct (low similarity/high distance).

Once generated, the embeddings are stored, allowing for efficient reuse in subsequent similarity computations. To measure the similarity between different columns, the system employs mathematical similarity metrics such as cosine similarity or Euclidean distance. Cosine similarity measures the cosine of the angle between two vectors, emphasizing the orientation rather than the magnitude, making it particularly suited for identifying semantic closeness in high-dimensional spaces. Alternatively, Euclidean distance can be used to measure the straight-line distance between vectors, providing another dimension of comparison depending on the clustering needs or domain requirements.

To ensure scalability and computational efficiency, the approach avoids constructing full similarity matrices, which would require O(n²) computations for n columns and result in significant overhead at larger scales. Instead, the system uses optimized similarity search algorithms, such as approximate nearest neighbour (ANN) search techniques, to efficiently retrieve the most semantically similar columns without exhaustive pairwise comparisons. This enables the system to perform on-demand similarity searches or clustering operations in a highly scalable manner, even when processing datasets containing a large number of columns.

In certain embodiments, the system may further organize the embedded vectors using indexing structures such as k-d trees, HNSW (Hierarchical Navigable Small World) graphs, or vector databases to accelerate the similarity search and clustering processes.

By leveraging powerful pre-trained embeddings combined with efficient similarity computation techniques, the disclosed system achieves robust semantic clustering of structured and unstructured data columns with significantly reduced computational overhead, thereby enhancing the scalability, speed, and accuracy of structured and unstructured data management.

In one embodiment, the clustering uses at least one of a cosine similarity and a Euclidean distance between the embeddings for measuring similarity between the plurality of entities.

A user interface is provided, configured to present clustering results to a user and enable submission of feedback related to the accuracy of cluster assignments. The user interface displays one or more clustered groups of entities and provides options for the user to label individual entities, sub-clusters, or entire clusters as either a true positive or a false positive. The feedback may further include an optional confidence score indicating the user's level of certainty regarding the correctness of the classification. In certain embodiments, the user interface may enable batch labelling operations, wherein multiple entities or clusters are collectively marked to streamline user input. Additionally, the system may provide semi-automated suggestions for labelling, based on prior feedback patterns or heuristic rules, which the user may accept, modify, or reject. All feedback is captured and stored in association with corresponding entity metadata, and is utilized to iteratively refine clustering models, improve future classification accuracy, and adapt system behaviour based on user-driven self-calibration.

In one embodiment, the feedback enables meaningful interaction by providing visual cues and interactive elements to the user. The user can seamlessly select a column of interest from the dataset for detailed exploration and analysis. The visual cues an interactive elements allows the user to adjust the relative importance of schema (header information), content (data meaning and format) and morphological components (structural properties) in determining similarity.

At least one of the plurality of entities is reclassified based on the user feedback received via the user interface. The reclassification operation adjusts the cluster assignments, entity labels, or underlying model parameters in accordance with the identification of true positives and false positives provided by the user. The system is configured to iteratively apply the feedback, thereby progressively refining the artificial intelligence model employed for entity detection, embedding generation, and clustering. In certain embodiments, the refinement includes retraining, fine-tuning, or dynamic adjustment of model weights, thresholds, or decision boundaries. The iterative reclassification process facilitates adaptive self-calibration of structured and unstructured data management, enabling the system to autonomously improve classification accuracy, reduce error rates over time, and respond effectively to evolving data patterns or user preferences.

In one embodiment, the feedback on the clustering of entities is utilized to directly assign initial classifications to one or more clusters, wherein the feedback comprises at least one of confirming a cluster as representative of a classification category and modifying a cluster to define a new classification category, thereby enabling initial classification of entities. The user is allowed to assign a classification label directly to the cluster (for example, ‘email addresses’, ‘zip codes’, ‘product ids’ and so on). Subsequently, the cluster may be modified (split, merged or redefined).

It must be noted that similarity between columns can vary in effectiveness depending on the specific characteristics of the column's contents. This variability arises from the fact that columns with different types or distributions of data may require different thresholds to determine whether two columns are “similar enough.” For instance, a column composed entirely of consistent data types, such as 2-digit numbers, may need a higher similarity threshold for declaring two columns as similar compared to a column that contains mixed data types, such as both 2- and 3-digit numbers.

To accommodate such variability, the system employs an adaptive self-calibration method to fine-tune its similarity calculations dynamically, based on the inherent characteristics of each column's data distribution. This ensures that the similarity measure is contextually sensitive and capable of adjusting its strictness based on the content of the columns being compared.

In one embodiment, the self-calibration is performed by dividing each column into non-overlapping subsets. Each subset is a representative sample of the column's data, allowing the system to analyse smaller, more manageable portions of the data without loss of generality. This splitting process is essential because it enables the system to compute similarity metrics that are contextually informed by the column's internal structure, rather than relying solely on the entire dataset at once. After the column is split into subsets, the system calculates the similarity between subsets. This can involve comparing the semantic or numerical similarity of each subset, using methods such as cosine similarity, Euclidean distance, or other distance metrics. By comparing the internal consistency of the subsets, the system can derive a more nuanced measure of how similar or dissimilar the data in each subset is, which is useful for columns with heterogeneous data distributions. The self-calibration process is not limited to a single comparison. Instead, it is performed multiple times for different subsets of the column, allowing the system to capture variability in the column's data and adjust the threshold accordingly. For example, a column containing a mix of numeric and categorical values may be split into subsets that focus specifically on numeric data and subsets that focus on categorical data. This enables the system to calculate similarity metrics tailored to each distinct subset type.

After performing similarity comparisons on different subsets, the results are aggregated into a similarity threshold or distribution that reflects the column's data characteristics. This is referred as the aggregated score 310D. This threshold or distribution serves as a modulating factor in future similarity calculations between columns. When two columns are compared later in the process, their similarity scores 310B are adjusted according to the column-specific calibration threshold. For instance, if a column has a high degree of internal consistency (such as a column of consistent 2-digit numbers), the threshold for declaring two columns as similar might be raised, requiring stricter similarity for a match. Conversely, columns with more diverse data distributions might have a lower similarity threshold, allowing for more flexible similarity evaluations.

In another embodiment, the self-calibration enables dynamic adjustment of the similarity metrics based on internal column characteristics.

Over time, as the system processes more data, the self-calibration mechanism continuously refines the similarity threshold for each column. This dynamic adjustment ensures that the system remains accurate and efficient even as the nature of the data evolves. By performing self-calibration, the system can adapt to various types of data and adjust its similarity measures based on the observed properties of each column, ensuring that similarity comparisons are both context-sensitive and scalable.

In one embodiment, the user is allowed to select a column of interest from the classified plurality of entities for analysis. This allows

In accordance with an embodiment of the present disclosure, a computer-implemented method implemented by a classification system is provided. The computer-implemented method includes detecting, by a pre-trained intelligence model, a plurality of entities within a text document of structured and unstructured data, generating, from each of the plurality of entities, multi-level embeddings configured to capture contextual relationships, wherein the embeddings enable calculation of similarity metrics and generation of similarity-based signatures, clustering the plurality of entities based on the embeddings for at least one of visualization and batch classification wherein the clustering comprises a first mode configured to classify the plurality of entities based on header information and data types and a second mode configured to classify the plurality of entities based on semantic meaning and format characteristics of one or more column data, providing, by a user interface, an option for a user to submit feedback on the clustering results, wherein the feedback comprises identification of cluster assignments as one of a true positive and a false positive and reclassifying at least one of the plurality of entities based on user feedback wherein the reclassification iteratively refines the artificial intelligence model and facilitates adaptive self-calibration of structured and unstructured data management.

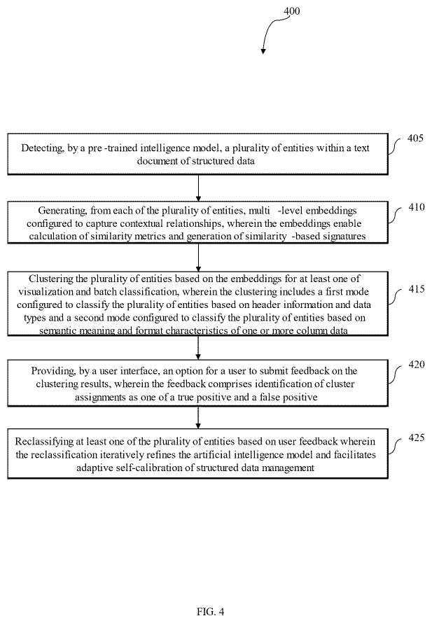

FIG. 4 illustrates a method implemented by the classification system in accordance with an embodiment of the present disclosure. Although the method 400 may be implemented in a variety of devices, but for ease of explanation, the description of methods 400 is provided in reference to the above-described classification system 115. The order in which the methods 400 is described is not intended to be construed as a limitation, and any number of the described method steps may be combined in any order to implement the methods 400, or an alternative method. It may be understood that steps of the methods 400 may be performed in the system 100. The steps of the methods 400 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At step 405, a plurality of entities is detected within a text document of structured and unstructured data, by a pre-trained intelligence model.

At step 410, multi-level embeddings are generated from each of the plurality of entities, wherein the multi-level embeddings are configured to capture contextual relationships, wherein the embeddings enable calculation of similarity metrics and generation of similarity-based signatures.

At step 415, the plurality of entities are clustered based on the embeddings for at least one of visualization and batch classification. The clustering comprises a first mode configured to classify the plurality of entities based on header information and data types and a second mode configured to classify the plurality of entities based on semantic meaning and format characteristics of one or more column data.

At step 420, an option for a user to submit feedback on the clustering results is provided via a user interface, wherein the feedback comprises identification of cluster assignments as one of a true positive and a false positive.

At step 425, at least one of the plurality of entities is reclassified based on user feedback wherein the reclassification iteratively refines the artificial intelligence model and facilitates adaptive self-calibration of structured and unstructured data management.

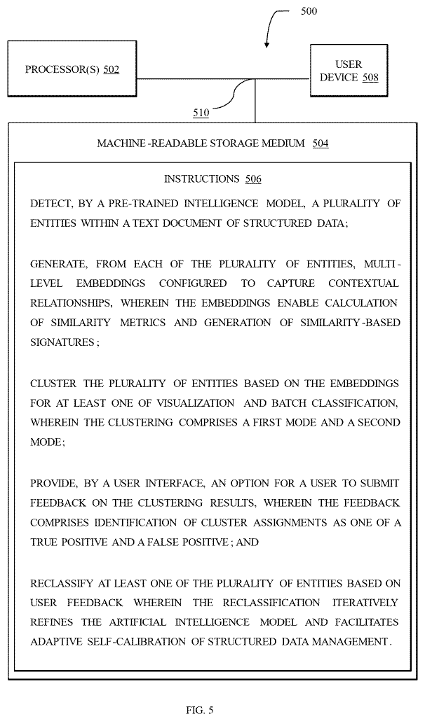

FIG. 5 illustrates a computing environment implementing a non-transitory computer-readable storage medium for classification and reclassification of structured and unstructured data using similarity-based signatures in accordance with an embodiment of the present disclosure.

In an example, the computing environment 500 includes processor(s) 502 communicatively coupled to a non-transitory computer-readable medium 504 (alternatively referred to as machine-readable storage medium) through a communication link 510. In an example implementation, the computing environment 500 may be a classification system 115. The classification system 115 in turn may be communicatively coupled to the database through a communication network. In an example, the processor(s) 502 may have one or more processing resources for fetching and executing computer-readable instructions from the non-transitory computer readable medium 504. The processor(s) 502 and the non-transitory computer readable medium 504 may be implemented, for example, in processor 302 (as has been described in conjunction with the preceding figures).

The non-transitory computer readable medium 504 may be, for example, an internal memory device or an external memory device. In an example implementation, the communication link 510 may be a network communication link. The processor(s) 502 and the non-transitory computer readable medium 504 may also be communicatively coupled to a computing device 508 over the network.

In an example implementation, the non-transitory computer readable medium 504 includes a set of computer readable instructions 506 (referred to as instructions 506) which may be accessed by the processor(s) 502 through the communication link 510.

The instructions 506 may cause the processor(s) 502 to detect, by a pre-trained intelligence model, a plurality of entities within a text document of structured and unstructured data, generate, from each of the plurality of entities, multi-level embeddings configured to capture contextual relationships, wherein the embeddings enable calculation of similarity metrics and generation of similarity-based signatures, cluster the plurality of entities based on the embeddings for at least one of visualization and batch classification, wherein the clustering comprises a first mode configured to classify the plurality of entities based on header information and data types and a second mode configured to classify the plurality of entities based on semantic meaning and format characteristics of one or more column data, provide, by a user interface, an option for a user to submit feedback on the clustering results, wherein the feedback comprises identification of cluster assignments as one of a true positive and a false positive, reclassify at least one of the plurality of entities based on user feedback wherein the reclassification iteratively refines the artificial intelligence model and facilitates adaptive self-calibration of structured and unstructured data management.

The disclosed system and method for classification and reclassification of structured and unstructured data using similarity-based signatures provide several technical advantages specific to their functionality. By using multi-level embeddings and similarity-based signatures, the system achieves more precise grouping and classification of structured and unstructured data columns, even when data is noisy or lacks clear headers. The system presents clustering results visually and allows user feedback (true positive/false positive marking), making the process transparent and user-guided rather than a “black box” AI. By combining semantic, distributional, and morphological signals through a classifier, the system increases robustness and reduces false positives, achieving a better balance between precision and recall. The visual cues and interactive elements empowers the user to fine-tune similarity assessments based on specific requirements and contexts. Further, by allowing the user to filter the dataset facilitates deeper exploration by narrowing down the scope to related or distinct data segments within the dataset. The interactive interface for self-calibration allows for tailored similarity measurements, improving the accuracy and relevance of data comparisons. Intelligent clustering, consistency scoring, and self-calibration reduce dependency on manual inspection, minimizing human oversight errors.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system comprising:
a processor; and
a machine-readable storage medium comprising instructions executable by the processor to:
detect, by a pre-trained intelligence model, a plurality of entities within a text document of structured and unstructured data;
generate, from each of the plurality of entities, multi-level embeddings configured to capture contextual relationships, wherein the embeddings enable calculation of similarity metrics and generation of similarity-based signatures;
cluster the plurality of entities based on the embeddings for at least one of visualization and batch classification, wherein the clustering comprises:
a first mode configured to classify the plurality of entities based on header information and data types; and
a second mode configured to classify the plurality of entities based on semantic meaning and format characteristics of one or more column data;
provide, by a user interface, an option for a user to submit feedback on the clustering results, wherein the feedback comprises identification of cluster assignments as one of a true positive and a false positive; and
reclassify at least one of the plurality of entities based on user feedback wherein the reclassification iteratively refines the artificial intelligence model and facilitates adaptive self-calibration of structured and unstructured data management.

2. The system as claimed in claim 1, wherein the self-calibration is performed by dividing each column into non-overlapping subsets and subsequently comparing the similarities between the said subsets to obtain an aggregated result that is used to compare a first column and a second column.

3. The system as claimed in claim 2, wherein to cause to aggregate the similarities into a similarity threshold for further comparison of the plurality of columns.

4. The system as claimed in claim 1, wherein the self-calibration enables dynamic adjustment of the similarity metrics based on internal column characteristics.

5. The system as claimed in claim 1, wherein the embeddings is All-MiniLM-L6-v2 to distinguish between the plurality of columns.

6. The system as claimed in claim 1, wherein to cause to allow the user to select a column of interest from the classified plurality of entities for analysis.

7. The system as claimed in claim 1, wherein to cause to display one or more similarities between the plurality of columns using a distance metric via the user interface.

8. The system as claimed in claim 4, wherein to cause to allow the user to adjust schema, content and morphological components to determine the similarities between the plurality of columns.

9. The system as claimed in claim 3, wherein to cause to enable the user to filter the plurality of entities to focus on a plurality of columns with the selected column of interest.

10. The system as claimed in claim 1, wherein to cause to assign a consistency score to perform at least one of direct the user to the column of interest for review and automatically update the column of interest.

11. The system as claimed in claim 1, wherein to cause to generate a multi-level similarity score by combining a plurality of similarity measurements using a classifier.

12. The system as claimed in claim 1, wherein the clustering uses at least one of a cosine similarity and a Euclidean distance between the embeddings for measuring similarity between the plurality of entities.

13. The system as claimed in claim 1, wherein each column of the plurality of entities is embedded as a high-dimensional vector.

14. The system as claimed in claim 1, wherein the embeddings are stored in a database to enable further clustering as required.

15. The system as claimed in claim 14, wherein the stored embeddings are used to perform clustering.

16. The system as claimed in claim 1, wherein the first mode signifies a table schema clustering, and the second mode signifies a column content clustering.

17. The system as claimed in claim 1, wherein the feedback enables meaningful interaction by providing visual cues and interactive elements to the user.

18. The system as claimed in claim 1, wherein the feedback on the clustering of entities is utilized to directly assign initial classifications to one or more clusters, wherein the feedback comprises at least one of confirming a cluster as representative of a classification category and modifying a cluster to define a new classification category, thereby enabling initial classification of entities.

19. A computer-implemented method implemented by a classification system, the method comprising:
detecting, by a pre-trained intelligence model, a plurality of entities within a text document of structured and unstructured data;
generating, from each of the plurality of entities, multi-level embeddings configured to capture contextual relationships, wherein the embeddings enable calculation of similarity metrics and generation of similarity-based signatures;
clustering the plurality of entities based on the embeddings for at least one of visualization and batch classification, wherein the clustering comprises:
a first mode configured to classify the plurality of entities based on header information and data types; and
a second mode configured to classify the plurality of entities based on semantic meaning and format characteristics of one or more column data;
providing, by a user interface, an option for a user to submit feedback on the clustering results, wherein the feedback comprises identification of cluster assignments as one of a true positive and a false positive; and
reclassifying at least one of the plurality of entities based on user feedback wherein the reclassification iteratively refines the artificial intelligence model and facilitates adaptive self-calibration of structured and unstructured data management.

20. A non-transitory computer-readable storage medium comprising instructions, the instructions being executable by a processing resource to:
detect, by a pre-trained intelligence model, a plurality of entities within a text document of structured and unstructured data;
generate, from each of the plurality of entities, multi-level embeddings configured to capture contextual relationships, wherein the embeddings enable calculation of similarity metrics and generation of similarity-based signatures;
cluster the plurality of entities based on the embeddings for at least one of visualization and batch classification, wherein the clustering comprises:
a first mode configured to classify the plurality of entities based on header information and data types; and
a second mode configured to classify the plurality of entities based on semantic meaning and format characteristics of one or more column data;
provide, by a user interface, an option for a user to submit feedback on the clustering results, wherein the feedback comprises identification of cluster assignments as one of a true positive and a false positive; and
reclassify at least one of the plurality of entities based on user feedback wherein the reclassification iteratively refines the artificial intelligence model and facilitates adaptive self-calibration of structured and unstructured data management.
